(19) United States
(12) Patent Application Publication
(10) Pub. No.: US 2025/0378426 A1
(43) Pub. Date: Dec. 11, 2025

(54) INFORMATION PROCESSING DEVICE

(71) Applicant: TOYOTA JIDOSHA KABUSHIKI KAISHA, Toyota-shi (JP)

(72) Inventors: Isao SATO, Nagoya-shi (JP); Kenji TAKAHASHI, Toyota-shi (JP); Daichi NAGATA, Nagoya-shi (JP); Yasuhide KURIMOTO, Kasugai-shi (JP); Toshio UCHIYAMA, Toyota-shi (JP); Kenji ZAITSU, Nagoya-shi (JP); Takayuki KANDA, Okazaki-shi (JP)

(73) Assignee: TOYOTA JIDOSHA KABUSHIKI KAISHA, Toyota-shi (JP)

(21) Appl. No.: 19/169,164

(22) Filed: Apr. 3, 2025

(30) Foreign Application Priority Data
Jun. 11, 2024 (JP) 2024-094311

(51) Int. Cl. G06Q 10/30; B60L 53/80

(52) U.S. Cl. CPC G06Q 10/30; B60L 53/80

(57) ABSTRACT

Provided is a control unit that is configured to execute acquiring first information that relates to a battery that is needed by a first user who performs secondary usage of the battery, and that includes at least information regarding a time limit for collecting the battery, acquiring second information regarding the battery that is in use by a plurality of second users, and transmitting, to a terminal of a second user that is at least part of the second users, a notification regarding provision of the battery, in accordance with a condition that is changed depending on the time limit, the first information, and the second information.

### CROSS-REFERENCE TO RELATED APPLICATION

This application claims priority to Japanese Patent Application No. 2024-094311 filed on Jun. 11, 2024, incorporated herein by reference in its entirety.

### BACKGROUND

### 1. Technical Field

The present disclosure relates to an information processing device.

### 2. Description of Related Art

WO 2015/12144 discloses that a secondary usage destination of a battery that is in use is decided in advance, before end of use thereof, based on a predicted end of use time. Japanese Unexamined Patent Application Publication No. 2021-131671 (JP 2021-131671 A), Japanese Unexamined Patent Application Publication No. 2021-136828 (JP 2021-136828 A), and Japanese Unexamined Patent Application Publication No. 2020-119369 (JP 2020-119369 A) disclose related art.

### SUMMARY

An object of the present disclosure is to facilitate collecting a needed number of batteries, when necessary, for secondary usage of the batteries.

One aspect of the present disclosure is an information processing device, including a control unit that is configured to execute
acquiring first information that relates to a battery that is needed by a first user who performs secondary usage of the battery, and that includes at least information regarding a time limit for collecting the battery,
acquiring second information regarding the battery that is in use by a plurality of second users, and
transmitting, to a terminal of a second user that is at least part of the second users, a notification regarding provision of the battery, in accordance with a condition that is changed depending on the time limit, the first information, and the second information.

Also, another aspect of the present disclosure is an information processing method for causing a computer to execute the above information processing, a program for causing a computer to execute the information processing method, and a computer-readable storage medium storing the program in a non-transitory manner.

According to the present disclosure, in secondary usage of batteries, a needed number of batteries can be easily collected when necessary.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram schematically illustrating an example of configurations of a vehicle, a first user terminal, a server, and a second user terminal constituting a system according to an embodiment;

FIG. 2 is a sequence diagram illustrating an overall process of the system when a request for providing a battery is made to a second user according to the embodiment;

FIG. 3 is a flowchart illustrating a process of requesting a second user to provide a battery in the server according to the first embodiment;

FIG. 4 is a flowchart illustrating a process of requesting a second user to provide a battery in the server according to the second embodiment;

FIG. 5 is a flow chart showing a process of requesting a second user to provide batteries in the servers according to the third embodiment; and

FIG. 6 is a flowchart illustrating a process performed when the server according to the fourth embodiment requests the second user to provide a battery.

### DETAILED DESCRIPTION OF EMBODIMENTS

It is also conceivable that a needed number of batteries are not collected when the batteries are used for secondary usage. Here, it is assumed that a battery for a vehicle (hereinafter, also referred to as an in-vehicle battery) is reused as a stationary battery (hereinafter, also referred to as a stationary battery). The stationary battery may need a plurality of in-vehicle batteries. In this case, there is a need to collect a plurality of on-vehicle batteries from a plurality of vehicles. However, it may be difficult to collect a plurality of batteries at the same time. The in-vehicle battery can maintain the quality only for about three months, for example, after being removed from the vehicle. Therefore, if the needed number of batteries is not collected within three months after the user acquires the first in-vehicle battery, the user cannot use the first in-vehicle battery acquired by the user. As described above, the battery collected by the user may be wasted.

In order to solve such a problem, an information processing device according to an aspect of the present disclosure includes a control unit. The control unit acquires first information that relates to the battery needed by the first user who performs secondary usage of the battery, and that includes at least information related to a time limit for collecting the battery. The first user is, for example, a business operator that performs secondary usage of a battery. This battery is a battery that has been used elsewhere in the past, and is a battery that is used for secondary usage. The battery may be, for example, a battery mounted on a BEV (Battery Electric Vehicle). The time limit for collecting the batteries may be, for example, the time limit for which the batteries already collected as described above can be used. By acquiring the first information, the control unit can grasp the time limit for collecting the batteries. Further, the first information may include first position information regarding a position where the battery is used, or first material information regarding a material of the battery needed by the first user. In addition, the first information may include information on a degree of deterioration of the battery allowed by the first user. The first information may be transmitted from a terminal of the first user.

In addition, the control unit acquires second information regarding the battery in use by the plurality of second users. The second information may include second positional information regarding a position where the battery is being used, second material information regarding a material of the battery being used by the plurality of second users, or information regarding a degree of deterioration of the battery. The battery in use by the second user is a battery that the first user may use for secondary usage. The second information may be obtained from a terminal of the second user, or the battery may be obtained from, for example, a vehicle in use.

Further, the control unit transmits a notification related to the provision of the battery to a terminal of at least a part of the second users of the plurality of second users in accordance with a condition changed in accordance with the time limit, the first information, and the second information. The “condition changed according to the time limit” includes, for example, a condition related to the price for the provision of the battery determined according to the time limit, a condition related to a predetermined region for transmitting the notification, a condition related to the material of the battery, or a condition related to the degree of deterioration of the battery. It should be noted that the condition may be a condition that is relaxed according to a period up to the time limit for collecting the battery.

For example, the control unit may increase the price for providing the battery as the period up to the time limit is shorter. Then, the control unit may notify the second user of the price. As the price for providing the battery increases, the number of users who intend to provide the battery increases, so that the battery can be easily collected. Further, for example, the control unit may increase the predetermined region as the period up to the time limit is shorter. This makes it possible to request the provision of a battery over a wider region. This makes it easier to collect batteries. For example, when the period up to the time limit is equal to or longer than the predetermined period, the control unit may transmit the notification to the terminal of the second user corresponding to the battery of the same material as the material of the battery needed by the first user among the batteries in use by the plurality of second users. When the period up to the time limit is less than the predetermined period, the control unit may transmit the notification to the terminal of the second user irrespective of the material of the battery needed by the first user. That is, when the period to the time limit is shortened, the battery is easily collected by collecting the battery regardless of the material of the battery. Further, for example, the control unit may increase the allowable degree of deterioration of the battery as the period up to the time limit becomes shorter. This makes it easier to collect batteries. As described above, the control unit eases the condition for collecting the battery in response to the shortening of the time limit for collecting the battery, thereby making it easier to collect the battery.

Hereinafter, embodiments of the present disclosure will be described with reference to the drawings. The configuration of the following embodiment is an example, and the present disclosure is not limited to the configuration of the embodiment. Further, the following embodiments can be combined as much as possible.

### First Embodiment

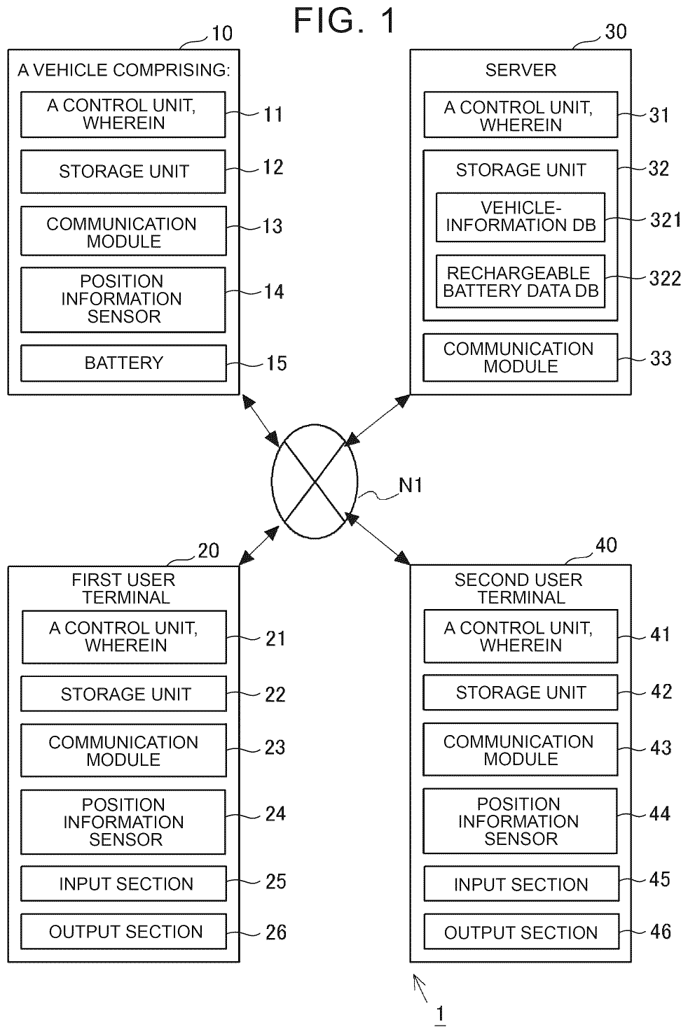

FIG. 1 is a block diagram schematically illustrating an example of configurations of a vehicle 10, a first user terminal 20, a server 30, and a second user terminal 40 constituting the system 1 according to the present embodiment. In the example illustrated in FIG. 1, the system 1 includes a vehicle 10 on which a battery 15 is mounted, a first user terminal 20 used by a first user who collects a battery to be subjected to secondary usage, a server 30, and a second user terminal 40 which is a terminal used by a second user who is a user of the vehicle 10. There may be a plurality of vehicles 10, first user terminals 20, and second user terminals 40. The vehicles 10, the first user terminals 20, the servers 30, and the second user terminals 40 are connected to each other via a networked N1. Note that the network N1 may be, for example, a global public communication network such as the Internet (WAN (Wide Area Network) or another communication network. The network N1 may include a telephone communication network such as a mobile telephone, and a radio communication network such as Wi-Fi.

The vehicle 10 is, for example, a vehicle on which batteries 15 such as BHV are mounted. The battery 15 supplies electric power to an electric motor that drives the vehicle 10. The battery 15 is a battery of which secondary usage can be performed. The vehicle 10 includes a control unit 11, a storage unit 12, a communication module 13, a position information sensor 14, and a battery 15. The control unit 11 is an arithmetic unit that realizes various functions of the vehicle 10 by executing a predetermined program. The control unit 11 can be realized by, for example, a hardware processor such as a CPU. The storage unit 12 is a unit that stores information, and is configured by a storage medium such as a RAM, a magnetic disk, or a flash memory. The storage unit 12 stores a program executed by the control unit 11, data used by the program, and the like.

The communication module 13 is a communication unit for connecting the vehicles 10 to the networked N1. In the present embodiment, vehicles 10 can communicate with other devices (for example, servers 30) over a networked N1 using a mobile communication service such as 3G, LTE, 5G, 6G. The position information sensor 14 acquires position information (for example, latitude and longitude) at a predetermined cycle. The position information sensor 14 is, for example, a GPS (Global Positioning System) receiver, a radio communication unit, or the like.

The control unit 11 of the vehicle 10 transmits vehicle information including information on the state of the battery 15 to the server 30 at a predetermined timing. The predetermined timing may be when the vehicle 10 is activated or parked, or may be every predetermined time. The control unit 11 may calculate, for example, SOH (State of Health) and transmit SOH to the servers 30. Note that the control unit 11 may acquire SOH by using known methods. Further, the status of the batteries 15 transmitted by the control unit 11 to the servers 30 is not limited to SOH. For example, the control unit 11 may transmit SOC (State Of Charge), a lithium-deposition rate, or the like to the servers 30. The control unit 11 transmits the vehicle information to the server 30. The vehicle information includes, for example, a vehicle ID, a user ID, a battery ID, second position information regarding a position in which the battery 15 is used, second material information regarding a material of the battery 15, date and time information, and information (for example, SOH information) regarding a degree of deterioration of the battery 15. The battery 15 can be subjected to secondary usage in units of, for example, a cell, a stack, or a pack. The control unit 11 of the vehicle 10 may detect a state of deterioration for each unit such as a cell, a stack, or a pack, and transmit the detected state to the server 30.

The first user terminal 20 is a terminal used by the first user, and is, for example, a smart phone, a tablet terminal, a wearable terminal, or a PC (Personal Computer. The first user is, for example, a business operator that reuses the battery 15. An application software or a web browser for collecting batteries, for example, is installed in the first user terminal 20. The first user terminal 20 includes a control unit 21, a storage unit 22, a communication module 23, a position information sensor 24, an input unit 25, and an output unit 26. The control unit 21 of the first user terminal 20 can be realized by, for example, a hardware processor such as a CPU. The storage unit 22 is a unit that stores information, and is configured by a storage medium such as a RAM, a magnetic disk, or a flash memory. The storage unit 22 stores a program executed by the control unit 21, data used by the program, and the like. The communication module 23 and the position information sensor 24 of the first user terminal 20 have the same configuration as the communication module 13 and the position information sensor 14 of the vehicle 10.

The input unit 25 is a unit that receives an input operation or the like performed by a user, and includes, for example, a touch panel, a mouse, a keyboard, a microphone, or the like. The output unit 26 is a unit for presenting information to a user, and may include, for example, LCD (Liquid Crystal Display), EL (Electroluminescence), a speaker, a lamp, and the like. The input unit 25 and the output unit 26 may be configured as a single touch panel display.

The control unit 21 of the first user terminal 20 receives input of information (hereinafter, also referred to as secondary battery information) related to the battery 15 to be collected for secondary usage. The first user inputs the secondary battery information via the input unit 25. The secondary battery information includes a user ID, information related to a specification of the battery 15 needed by the first user, first position information related to a position where the battery 15 is used, first material information related to a material of the battery 15 needed by the first user, information related to a degree of deterioration of the battery 15 to be allowed, information related to an amount of allowable price, and information related to a time limit for collecting the battery 15. Note that the first user may perform registration in advance with respect to the server 30 via the input unit 25 of the first user terminal 20.

The second user terminal 40 is a terminal used by the second user, and is, for example, a smart phone, a tablet terminal, a wearable terminal, or a PC (Personal Computer. The second user terminal 40 may be a terminal mounted on the vehicle 10. An application software or a web browser that receives a notification from the server 30, for example, is installed in the second user terminal 40. The second user terminal 40 includes a control unit 41, a storage unit 42, a communication module 43, a position information sensor 44, an input unit 45, and an output unit 46. The control unit 41 of the second user terminal 40 can be realized by, for example, a hardware processor such as a CPU. The storage unit 42 is a unit that stores information, and is configured by a storage medium such as a RAM, a magnetic disk, or a flash memory. The storage unit 42 stores a program executed by the control unit 41, data used by the program, and the like. The communication module 43, the position information sensor 44, the input unit 45, and the output unit 46 of the second user terminal 40 have the same configuration as the communication module 23, the position information sensor 24, the input unit 25, and the output unit 26 of the first user terminal 20.

The control unit 41 of the second user terminal 40, upon receiving a notification regarding a request for provision of the battery 15 from the server 30, causes the display of the output unit 46 to display an image corresponding to the notification. The second user who sees the notification inputs the answer via the input unit 45 of the second user terminal 40. The control unit 41 that has received the input of the answer transmits information related to the answer to the server 30.

The server 30 can be configured as a computer including a processor (such as a CPU, GPU), a main storage device (such as a RAM, ROM), and a secondary storage device (such as an EPROM, a hard disk drive, and a removable medium). The secondary storage device stores an operating system (OS), various programs, various tables, and the like, and the programs stored therein are executed to realize respective functions (software modules) that meet predetermined objectives. The server 30 includes a control unit 31, a storage unit 32, and a communication module 33.

The control unit 31 is an arithmetic unit that realizes various functions of the server 30 by executing a predetermined program. The control unit 31 can be realized by, for example, a hardware processor such as a CPU. The control unit 31 may include a RAM, ROM, a cache memory, and the like. Details of the control unit 31 will be described later.

The storage unit 32 is a unit that stores information, and is configured by a storage medium such as a RAM, a magnetic disk, or a flash memory. The storage unit 32 stores a program executed by the control unit 31, data used by the program, and the like. In addition, a database (vehicle information DB321 and secondary battery information DB322) is constructed in the storage unit 32, and information collected from each vehicle 10 and information collected from each first user terminal 20 are stored in the database.

The vehicle information DB321 stores vehicle information received from the vehicle 10. The vehicle information includes a vehicle ID, a user ID, a battery ID, second position information, second material information, date and time information, and SOH information. The vehicle ID is identification information unique to the vehicle 10. The user ID is unique to the second user or the second user terminal 40. The battery ID is an identity unique to the battery 15. Note that the battery ID may be provided for each unit to be reused, for example. The second position information is information related to the position of the vehicle 10 when the information is transmitted from the vehicle 10, and is, for example, information indicated by coordinates. The second material information is information about the material of the battery 15. The date and time information is information on the date and time when SOH information is transmitted from the vehicles 10. SOH information is information about SOH of the batteries 15. The control unit 31 stores the vehicle information received from the vehicle 10 in the vehicle information DB321.

The secondary battery information DB322 stores information related to the battery 15 needed by the first user. In the secondary battery information DB322, at least information on the time limit for collecting the batteries 15 is stored in association with the user ID. Further, the secondary battery information DB322 includes information on the specifications of the battery 15 needed by the first user, first position information on the position where the battery 15 is used, first material information on the material of the battery 15 needed by the first user, information on the degree of deterioration of the battery 15 allowed, and information on the amount of price allowed. The control unit 31 stores the secondary battery information received from the first user terminal 20 in the secondary battery information DB322.

The communication module 33 is a communication interface for connecting the servers 30 to the network N1. The communication module 33 may be configured to include, for example, a network interface board, a wireless communication interface for wireless communication, and the like. The server 30 can perform data communication with the vehicle 10, the first user terminal 20, and the second user terminal 40 via the communication module 33.

Next, the control unit 31 of the server 30 will be described in detail. The control unit 31 of the server 30 acquires the secondary battery information from the first user terminal 20. Note that the control unit 31 may directly acquire the time limit for collecting the battery 15 from the first user terminal 20 as information on the time limit for collecting the battery 15. That is, the first user may determine the time limit. As another example, the control unit 31 may acquire information regarding the date on which the battery 15 is acquired, and calculate a time point at which a predetermined period of time has elapsed from the date on which the battery 15 is acquired as a time limit for collecting the battery 15. The predetermined period is, for example, three months.

Note that the control unit 31 may acquire the first position information and the first material information from the first user terminal 20. For example, if the position where the first user performs secondary usage of the battery 15 and the position where the second user is using the battery 15 is close, since the distance to carry the battery in the secondary usage of the battery 15 is shortened, it is possible to reduce the transportation cost. Therefore, by the control unit 31 acquiring the first position information, the cost can be reduced. The battery 15 includes a plurality of types of materials. Examples of the material of the batteries 15 include LFP and ternary systems. When a plurality of batteries 15 are used, there is a desire to unify the plurality of batteries using the same material, and therefore, the control unit 31 can respond to this desire by acquiring the first material information.

The second position information is a position of the vehicle 10 acquired by the position information sensor 14 of the vehicle 10. As another example, the second position information may be information regarding either the position of the second user terminal 40 acquired by the position information sensor 24 of the second user terminal 40 or the position input by the second user to the second user terminal 40 via the input unit 45. Further, the second material information may be information that can determine the material of the battery 15 used in the vehicle 10, and may be, for example, a vehicle body number of the vehicle 10. The control unit 31 of the server 30 may specify, for example, the material of the battery 15 mounted on the vehicle 10 from the vehicle body number based on the information stored in the storage unit 32. The degree of deterioration of the battery 15 may be calculated by the control unit 11 of the vehicle 10, or may be calculated by the control unit 31 of the server 30 based on data transmitted from the vehicle 10.

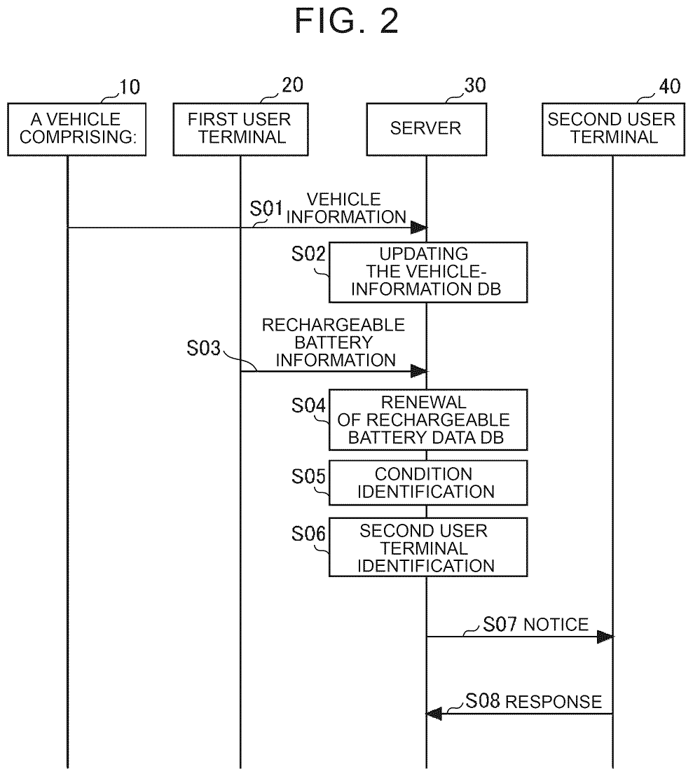

FIG. 2 is a sequence diagram illustrating an overall process of the system 1 when a request for providing the battery 15 is made to the second user according to the embodiment. The control unit 11 of the vehicle 10 transmits the vehicle data to the servers 30 at predetermined timings (S01). The control unit 31 of the server 30 that has received the vehicle information updates the vehicle information DB321 by storing the vehicle information in the vehicle information DB321 (S02). The processes in S01 and S02 are performed for the plurality of vehicles 10, respectively. In addition, upon receiving a predetermined input from the first user, the control unit 21 of the first user terminal 20 generates secondary battery information and transmits the secondary battery information to the servers 30 (S03). The control unit 31 of the server 30 updates the secondary battery information DB322 by storing the secondary battery information in the secondary battery information DB322 (S04). Further, the control unit 31 of the server 30 specifies a condition for collecting the battery 15 (hereinafter, also referred to as a battery collection condition) in accordance with the received secondary battery data (S05). This battery collection condition is an example of a condition that is changed according to a time limit. The battery collection condition includes, for example, a condition of collecting the battery 15 from within a predetermined region, collecting the battery 15 having a degree of deterioration equal to or less than a threshold value, or collecting the battery 15 of a predetermined material, and a condition of price. In addition, the control unit 31 of the server 30 identifies the second user terminal 40 corresponding to the battery-collection condition (S06). The control unit 31 transmits a notification regarding the provision of the batteries 15 to the identified second user terminal 40 (S07). Upon receiving the notification, the control unit 41 of the second user terminal 40 outputs an image corresponding to the notification to the display of the output unit 46. At this time, the control unit 41 of the second user terminal 40 outputs a user interface for inputting an answer to the notification. When the second user inputs an answer via the input unit 45, the control unit 41 of the second user terminal 40 transmits the answer to the server 30.

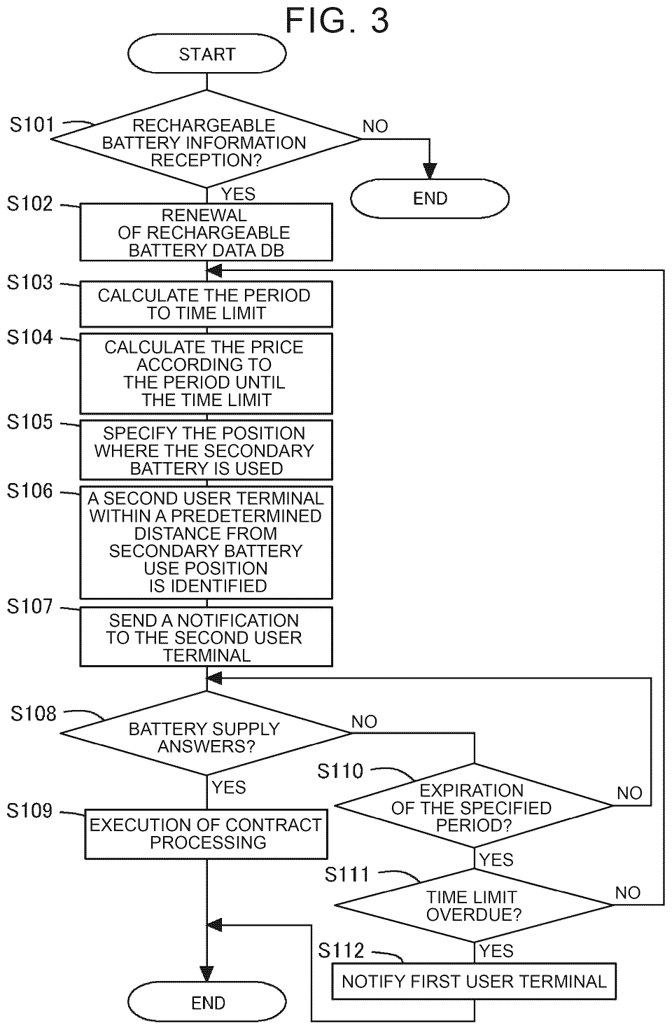

FIG. 3 is a flowchart showing processing when the server 30 according to the first embodiment requests the second user to provide the battery 15. The flowchart illustrated in FIG. 3 is executed in the server 30 at predetermined time intervals. It is assumed that the vehicle information DB321 stores needed information.

In S101, the control unit 31 determines whether or not the secondary battery data has been received from the first user terminal 20. The secondary battery information includes time limit information regarding the time limit for the first user to collect the battery 15, first position information regarding the position where the battery 15 is used, first material information regarding the material of the battery 15 needed by the first user, and the like. In addition, the secondary battery information may include, for example, information on the amount of price allowed by the first user. Further, the secondary battery information may include, for example, information on the degree of deterioration of the battery 15 allowed by the first user. If the control unit 31 makes an affirmative determination in S101, the process proceeds to S102, and if a negative determination is made, the routine ends. In S102, the control unit 31 updates the secondary battery information DB322 in accordance with the received secondary battery information.

In S103, the control unit 31 calculates a time period from the current time point to the time limit in accordance with the time limit data. Further, in S104, the control unit 31 calculates the price to be provided to the second user in accordance with the period up to the time limit. At this time, the control unit 31 increases the price as the period up to the time limit is shorter. When the amount of price allowed by the first user is set, the control unit 31 may increase the amount of price as the period up to the time limit becomes shorter, with the amount of price as an upper limit. Further, the relationship between the period up to the time limit and the price may be stored in the storage unit 32.

In S105, the control unit 31 specifies a position at which the first user performs secondary usage of the battery 15 (hereinafter, also referred to as a secondary battery use position). This position may be a position input by the first user via the input unit 25 of the first user terminal 20 or a position indicated by the position information of the first user terminal 20. The secondary battery use position is specified in accordance with the first position information. In S106, the control unit 31 identifies the second user terminal 40 located within a predetermined distance from the secondary battery-use position. As another example, the control unit 31 may specify the vehicle 10 located within a predetermined distance from the secondary battery use position. A predetermined distance from the secondary battery use position is an example of a predetermined region. The positions of the second user terminal 40 and the vehicle 10 are transmitted from the second user terminal 40 and the vehicle 10 at predetermined time intervals. Further, as another example, the control unit 31 may specify the second user terminal 40 or the vehicle 10 located within a predetermined distance from the secondary battery use position in accordance with the area or the address associated with the vehicle 10 registered by the second user. Note that the farther away from the secondary battery use position, the higher the cost for transporting the battery 15, and therefore, for example, the predetermined distance may be set based on the transportation cost allowed by the first user. In addition, the control unit 31 may specify the material and type of the mounted battery 15 only in the vehicle 10 that is the same as the material and type of the battery 15 that have been collected and the second user terminal 40 that corresponds to the vehicle 10, in the present S106. As yet another example, the control unit 31 may specify the material and the type of the battery 15 to be mounted only in the vehicle 10 that is the same as the material and the type of the battery 15 desired by the first user and the second user terminal 40 that corresponds to the vehicle 10 in the present S106.

In S107, the control unit 31 transmits a notification related to the provision of the batteries 15 to the second user terminal 40 identified in S106. The notification regarding the provision of the battery 15 includes information regarding each of the request for the provision of the battery 15 and the amount of the price given to the second user. In addition, the notification regarding the provision of the battery 15 includes a command for displaying each of the request for the provision of the battery 15 and the amount of the price given to the second user on the display of the output unit 46 of the second user terminal 40.

In S108, the control unit 31 determines whether or not an answer to the effect that the batteries 15 are to be provided is obtained from the second user terminal 40. In S108, if the control unit 31 makes an affirmative determination, the process proceeds to S109, and if it makes a negative determination, the process proceeds to S110. In S109, the control unit 31 executes a process for contracting with the second user to provide the batteries 15.

On the other hand, in S110, the control unit 31 determines whether or not a predetermined period has elapsed since the completion of S107 process. Here, the predetermined period is a period in which it is considered that an answer cannot be obtained from the second user terminal 40 even after waiting any longer. In S110, if the control unit 31 makes an affirmative determination, the process proceeds to S111, and if it makes a negative determination, the process returns to S108. In S111, the control unit 31 determines whether or not the time limit for collecting the batteries 15 has been exceeded. In S111, if the control unit 31 makes an affirmative determination, the process proceeds to S112, and if it makes a negative determination, the process returns to S103. In S112, the control unit 31 notifies the first user terminal 20 that the batteries 15 are not gathered. When the time limit has not been exceeded, in S103, the control unit 31 calculates the price corresponding to the time limit again. As a result, for example, the price can be gradually increased as the time limit approaches.

As described above, according to the present embodiment, as the time limit for the battery 15 to be collected by the control unit 31 becomes shorter, the price to be provided to the second user is increased, and therefore, the battery 15 is more likely to be collected. Therefore, when the battery 15 is used for secondary usage, the number of batteries 15 needed, when necessary, can be easily collected.

### Second Embodiment

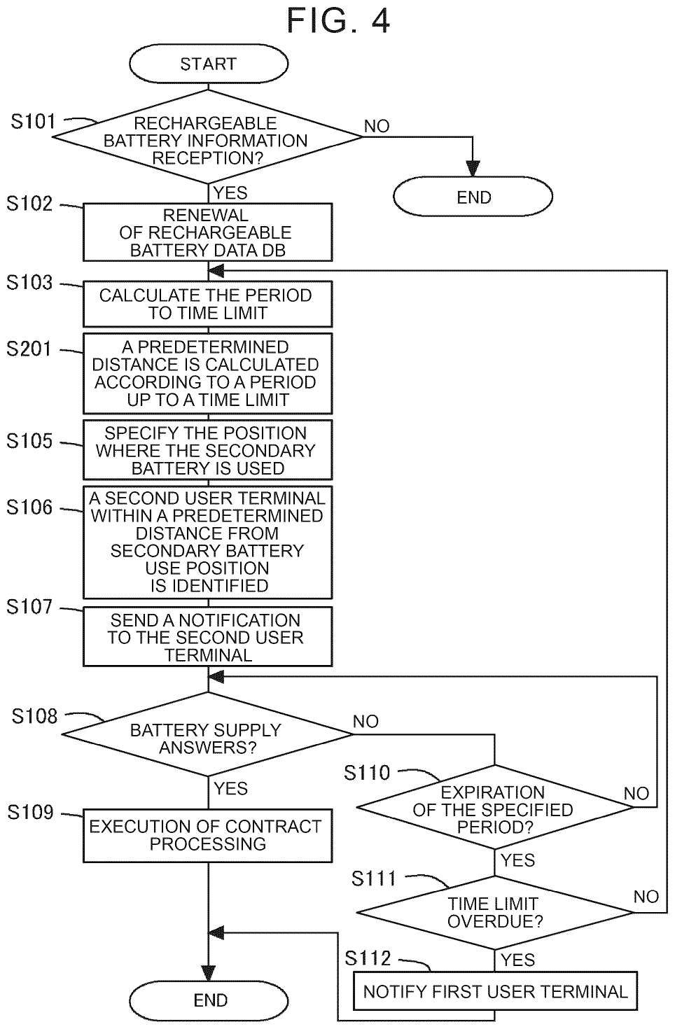

In the second embodiment, the notification is sent to the second user terminal 40 positioned farther in accordance with the period up to the time limit. FIG. 4 is a flowchart illustrating processing when the server 30 according to the second embodiment requests the second user to provide the battery 15. The flowchart illustrated in FIG. 4 is executed in the server 30 at predetermined time intervals. It is assumed that the vehicle information DB321 stores needed information. The description of the steps in which the same processing as the flowchart shown in FIG. 3 is executed is omitted.

In the flow chart shown in FIG. 4, when the process of S103 is completed, the process proceeds to S201. In S201, the control unit 31 calculates a predetermined distance according to the period until the time limit. At this time, the control unit 31 may increase the predetermined distance as the period until the time limit becomes shorter. This calculation formula is stored in the storage unit 32. Here, the predetermined distance is a predetermined distance used in S106. The longer the predetermined distance, the more the notification can be sent to the second user terminals 40 in a wider region, so that the battery 15 can be easily collected. On the other hand, when the battery 15 is collected from a wide region, there is a possibility that the transportation cost of the battery 15 will be high, and therefore, by shortening the predetermined distance when the period up to the time limit is long, the transportation cost is suppressed from being high. When S201 process is completed, the process proceeds to S105.

As described above, according to the present embodiment, as the time limit for the battery 15 to be collected by the control unit 31 becomes shorter, the range for searching for the second user is widened, so that the battery 15 is more likely to be collected. Therefore, when the battery 15 is used for secondary usage, the number of batteries 15 needed, when necessary, can be easily collected.

### Third Embodiment

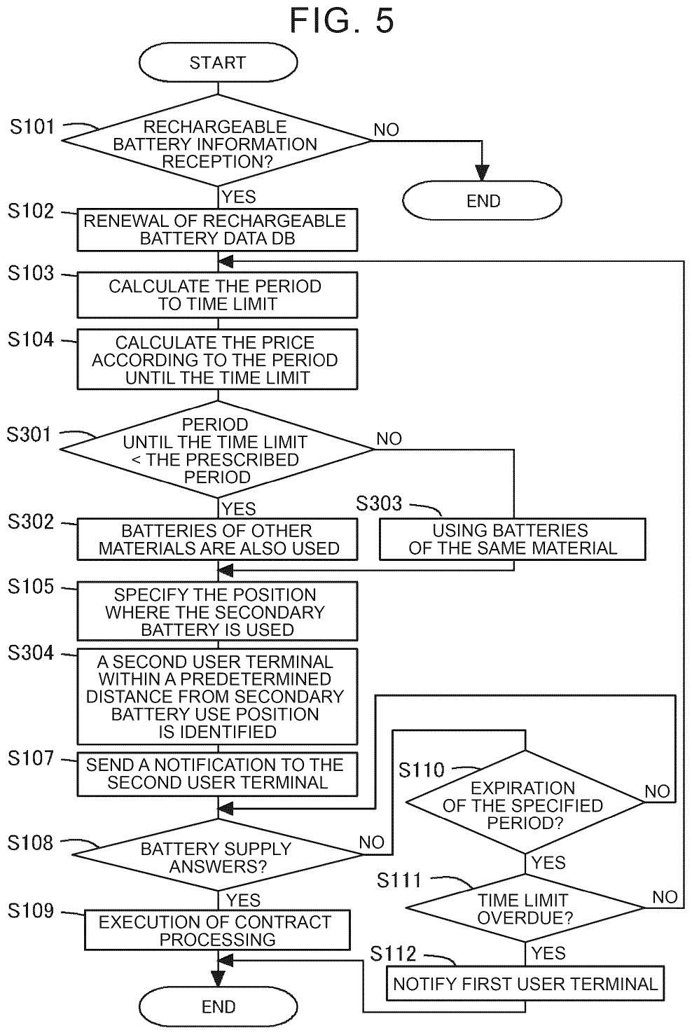

In the third embodiment, the control unit 31 relaxes the condition related to the material of the battery 15 in accordance with the period up to the time limit. FIG. 5 is a flowchart illustrating processing when the server 30 according to the third embodiment requests the second user to provide the battery 15. The flowchart illustrated in FIG. 5 is executed in the server 30 at predetermined time intervals. It is assumed that the vehicle information DB321 stores needed information. Further, the description of the steps in which the same processing as the flowchart shown in FIG. 3 is executed is omitted.

In the flow chart shown in FIG. 5, when the process of S104 is completed, the process proceeds to S301. In S301, the control unit 31 determines whether or not the period up to the time limit is less than the predetermined period. Here, the predetermined period is a period that serves as a trigger for relaxing the condition related to the material of the battery 15. The first user may input the predetermined period to the first user terminal 20 via the input unit 25. The longer the predetermined period, the easier it is to collect the battery 15, but it is more likely that the battery 15 of a material different from the battery 15 already collected by the first user will collect. In the present routine, the condition related to the material of the battery 15 is relaxed depending on whether or not it is less than the predetermined period, but instead, for example, the condition related to the material may be gradually relaxed at a plurality of timings. In S301, if the control unit 31 makes an affirmative determination, the process proceeds to S302, and if it makes a negative determination, the process proceeds to S303. In S302, the control unit 31 relaxes the condition for collecting the battery 15 so that the battery 15 of another material may also be used. For example, the battery 15 may be collected regardless of the material of the battery 15. When S302 process is completed, the process proceeds to S105. On the other hand, in S303, the control unit 31 sets the condition so as to use the batteries 15 of the same material. For example, the conditions may be set so as to collect the battery 15 of the same material as the battery 15 already collected, or the battery 15 of the material desired by the first user. When S303 process is completed, the process proceeds to S105.

When S105 process is completed, the process proceeds to S304. In S304, the control unit 31 identifies the second user terminal 40 located within a predetermined distance from the secondary battery-use position. As another example, the control unit 31 may specify the vehicle 10 located within a predetermined distance from the secondary battery use position. The second user terminal 40 and the vehicles 10 specified here are specified according to the conditions set by S302 or S303. When S303 process is completed, the process proceeds to S107.

As described above, according to the present embodiment, when the time period until the time limit for collecting the battery 15 by the control unit 31 is less than the predetermined time period, the battery 15 is easily collected in order to alleviate the condition regarding the material of the battery 15. Therefore, when the battery 15 is used for secondary usage, the number of batteries 15 needed, when necessary, can be easily collected.

### Fourth Embodiment

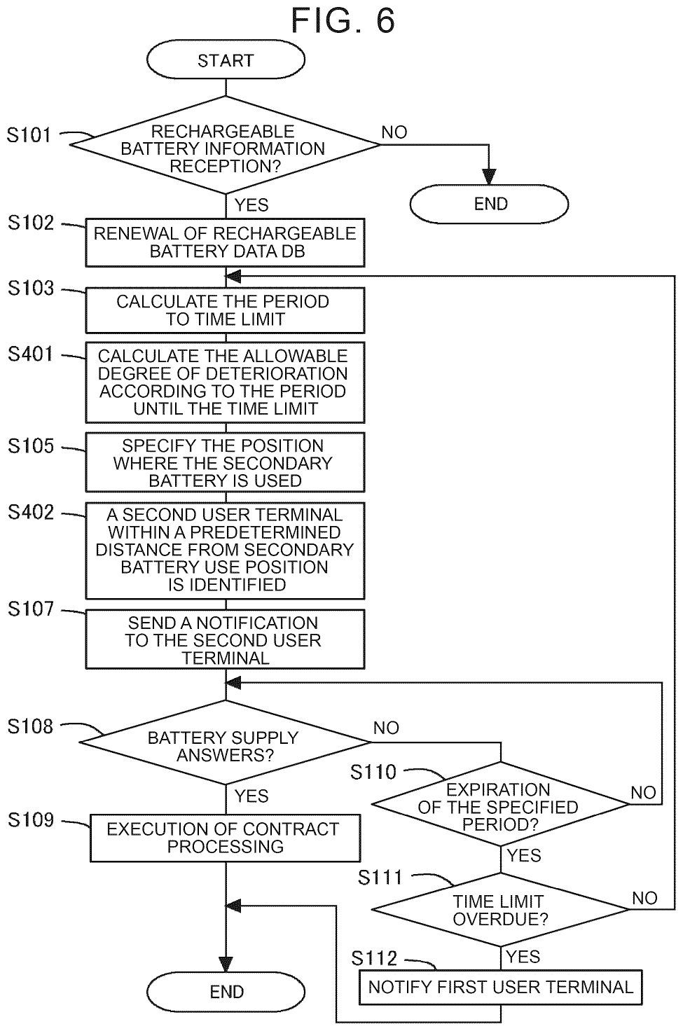

In the fourth embodiment, the control unit 31 relaxes the condition regarding the degree of deterioration of the battery 15 in accordance with the period up to the time limit. FIG. 6 is a flowchart showing processing when the server 30 according to the fourth embodiment requests the second user to provide the battery 15. The flowchart illustrated in FIG. 6 is executed in the server 30 at predetermined time intervals. It is assumed that the vehicle information DB321 stores needed information. Further, the description of the steps in which the same processing as the flowchart shown in FIG. 3 is executed is omitted.

In the flow chart shown in FIG. 6, when the process of S103 is completed, the process proceeds to S401. In S401, the control unit 31 calculates an allowable degree of deterioration according to the period until the time limit. Here, the limit of the allowable range of the degree of deterioration of the battery 15 to be collected is calculated. This calculation formula is stored in the storage unit 32. The higher the degree of deterioration of the battery 15 that is allowed, the more the battery 15 becomes within the allowable range, so that it is possible to send a notification to more second users. Therefore, the battery 15 can be easily collected. On the other hand, as the degree of deterioration of the collected battery 15 is higher, the life of the battery 15 to be used for secondary usage is shorter, and therefore, by keeping the degree of deterioration of the allowable battery 15 low when the period up to the time limit is long, the life of the battery 15 to be used for secondary usage is suppressed from being shortened. When S401 process is completed, the process proceeds to S105.

When S105 process is completed, the process proceeds to S402. In S402, the control unit 31 identifies the second user terminal 40 located within a predetermined distance from the secondary battery-use position. As another example, the control unit 31 may specify the vehicle 10 located within a predetermined distance from the secondary battery use position. The second user terminal 40 and the vehicle 10 specified here are the vehicle 10 in which the degree of deterioration of the batteries 15 mounted on the vehicle 10 is equal to or lower than the allowable degree of deterioration calculated by S401, and the second user terminal 40 corresponding to the vehicle 10. When S402 process is completed, the process proceeds to S107.

As described above, according to the present embodiment, since the control unit 31 relaxes the condition regarding the degree of deterioration of the battery 15 according to the period up to the time limit for collecting the battery 15, the battery 15 is easily collected. Therefore, when the battery 15 is used for secondary usage, the number of batteries 15 needed, when necessary, can be easily collected.

### Other Embodiments

The above-described embodiment is merely an example, and the present disclosure may be appropriately modified and implemented without departing from the gist thereof. The processes and means described in the present disclosure can be freely combined and implemented as long as there is no technical inconsistency. Further, the processing described as being performed by one apparatus may be performed by a plurality of apparatuses in a shared manner. Alternatively, the processes described as being performed by different devices may be performed by a single device. In a computer system, it is possible to flexibly change which hardware configuration (server configuration) realizes each function.

The present disclosure can also be realized by supplying a computer program that implements the functions described in the above embodiments to a computer, and one or more processors included in the computer read and execute the program. Such a computer program may be provided to a computer by a non-transitory computer readable storage medium connectable to a system bus of the computer, or may be provided to the computer via a network. Non-transitory computer-readable storage media include, for example, any type of disk, such as a magnetic disk (floppy disk, hard disk drive (HDD), etc.), an optical disk (CD-ROM, DVD disk, Blu-ray disk, etc.), read only memory (ROM), random access memory (RAM), EPROM, EEPROM, magnetic card, flash memory, optical card, any type of medium suitable for storing electronic instructions.

What is claimed is:

1. An information processing device, comprising: a control unit that is configured to execute
acquiring first information that relates to a battery that is needed by a first user who performs secondary usage of the battery, and that includes at least information regarding a time limit for collecting the battery,
acquiring second information regarding the battery that is in use by a plurality of second users, and
transmitting, to a terminal of a second user that is at least part of the second users, a notification regarding provision of the battery, in accordance with a condition that is changed depending on the time limit, the first information, and the second information.

2. The information processing device according to claim 1, wherein:
the condition includes a condition relating to a price for provision of the battery, the price being determined in accordance with the time limit;
the notification includes information relating to the price; and
the control unit sets the price to be higher in accordance with a period to the time limit being shorter.

3. The information processing device according to claim 1, wherein:
the first information includes first position information regarding a position at which the first user uses the battery;
the second information includes second position information regarding a position at which the second user is using the battery;
the condition is a predetermined region that includes a position at which the battery is used, and that includes a condition relating to a predetermined region to which the notification is to be transmitted; and
the control unit sets the predetermined region to be broader in accordance with a period to the time limit being shorter.

4. The information processing device according to claim 1, wherein:
the first information includes first material information regarding a material of the battery that is needed by the first user;
the second information includes second material information relating to a material of the battery being used by the second users;
the condition includes a condition relating to the material of the battery; and
when a period to the time limit is no shorter than a predetermined period, the control unit transmits the notification to a terminal of the second user corresponding to a battery of a same material as the material of the battery that is needed by the first user, from among the batteries in use by the second users, and when the period to the time limit is shorter than the predetermined period, transmits the notification to the terminal of the second user regardless of the material of the battery that is needed by the first user.

5. The information processing device according to claim 1, wherein:
the second information includes information regarding a degree of deterioration of the battery;
the condition includes a condition relating to the degree of deterioration of the battery; and
the control unit sets the degree of deterioration of the battery that is allowable, to be greater, in accordance with a period to the time limit being shorter.
